(19) United States
(12) Patent Application Publication
(10) Pub. No.: US 2003/0128681 A1
(43) Pub. Date: Jul. 10, 2003

(54) Method and apparatus for implementing an automatic repeat request ("ARQ") function in a fixed wireless communication system

(76) Inventor: Dennis Rauschmayer, Plano, TX (US)

Correspondence Address: Dennis Moore, Texas Instruments Incorporated, P.O. BOX 655474, M/S 3999, Dallas, TX, 75265, US

(21) Appl. No.: 10/035,667

(22) Filed: Dec. 29, 2001

(51) Int. Cl. H04Q 7/24

(52) U.S. Cl. 370/338; 370/349; 370/394

(57) ABSTRACT

ARQ is implemented in a fixed wireless communication system utilizing a demand access MAC, such as DOCSIS, and variable length PDUs, such as Ethernet packets, in messages between a base station and CPE. The base station inserts a sequence number into each PDU. The sequence numbers are members of a series, adjacent ones differing by the same factor. The CPE determines if any sequence number/s is/are missing from the packets of a received message, indicating a failure to receive their associated packets. The missing sequence numbers are included in a message back to the base station, which uses them to re-send the missing packets. The series may be generated according to a rule or algorithm available to both the base station and the CPE.

### RELATED APPLICATION

The invention of this application is related to the invention of commonly assigned, U.S. patent application Ser. No. ______ [Attorney Docket TI-33143], filed ______, 2001.

### FIELD OF THE INVENTION

The present invention relates to the implementation of an Automatic Repeat Request (“ARQ”) function in a fixed wireless communication system, and, more specifically to a methodology of performing ARQ in a fixed wireless system utilizing a demand assignment (“DA”) Media Access Control (“MAC”) protocol having variable length protocol data units (“PDU”).

### BACKGROUND OF THE INVENTION

Originally intended in the United States to be used primarily for instructional television broadcasts, the 2.5 to 2.7 GHz spectrum was found to be under-utilized for that purpose. Ultimately the FCC granted permission for this spectrum to be utilized by fixed wireless communication systems, including fixed Broadband Wireless Access (“BWA”), and, more specifically, Broadband Wireless Internet Access (“BWIA”) applications and systems.

Fixed wireless systems are typically used to expeditiously transmit large quanta of data on high volume networks, including those used to access the Internet or World Wide Web (“WWW”). A typical high-speed-high-volume data transfer network includes one or more remote originating stations, where data are created or stored. The created or stored data are transmitted to a base station which includes a transceiver. The base station may wirelessly communicate with the Customer Premises Equipment (“CPE”) of one or more subscribers or customers (“users” herein) who randomly and periodically desire to access such data via the CPE which may include a computer (PC, laptop, etc.), a computer system, a personal data assistant or a similar device. To this end, each item of CPE includes a wireless modem and associated facilities which includes a transceiver that can send data to and receive data from the transceiver in the base station. The data transfer network also includes a so-called “backbone” network on which various data and control signals are transmitted via the transceivers in the base station and the modems of the users.

If sufficient users are present in a given venue, multiple base stations (or “head ends”) may be set up in, and service, one or more respective adjacent or overlapping cells located in the venue. The data are transmitted from the data generators and/or data storage facilities in one or more originating stations to the base stations, typically via Hybrid Fiber/Coax (“HFC”) networks, but also via optical fibers, satellites, or other suitable links therebetween. The data are then transmitted by the base stations to the users within the venue. It has been found less expensive and more expedient to furnish these data from the base stations to the users via wireless techniques rather than by landlines or other non-wireless expedients.

In the foregoing regard, as with a cellular telephone network, it is necessary that two-way communications take place between each base station and each user's CPE served thereby. That is, each base station must be able to send data and information to the CPEs served thereby—so-called down link (down load or down stream) data—and each CPE must be able to send data and information to the base station serving it—so-called up link (up load or up stream) data. When the FCC gave permission to use the 2.5-2.7 GHz spectrum for fixed wireless communications, it also gave approval to the use of two-way communications thereover. As noted above, the data and information includes data desired to be accessed by the users and control signals for establishing and regulating the flow of data to the users.

It is well known that the quality of wireless communications can be adversely affected by such things as (i) meteorological events, solar flares and other nearby electrical systems, and (ii) objects and structures located between, or near the path between, a transmitter and its served receivers. Other structures and occurrences may have an effect on or influence the modulated electromagnetic waves attending this form of communication. Wireless communications may be deleteriously affected by interference, which may be caused by the items in (i), above, and fading, which may be caused by the items in (ii), above.

Fading is caused by fluctuations in the amplitude of a transmitted wireless electromagnetic signal. The fluctuations are the result of multipath transmission of the transmitted signal resulting from one or more reflections of the signal from objects between its transmitter and a receiver or near the path between the transmitter and the receiver. Each reflection creates an additional transmission path for the signal, and each path has associated therewith some time delay. The overall effect at the receiver of the transmitted signal and the reflected signal(s) is that of a vectorial combination of variously delayed signals, with each received signal contributing a different phase and magnitude. There results a standing wave pattern between the transmitter and the receiver, where fading is caused by changes in magnitude versus spatial location.

Fading—whether flat fading or frequency selective fading—maybe minimized, if not eliminated, by various signal processing techniques, referred to as channel equalization, including Decision Feedback Equalization (“DFE”). Depending on the various factors, successful channel equalization can represent major labor effort and monetary expenditure. If fading occurs because of reflections from stationary objects, such as buildings, the standing wave pattern is static in space. If the signals are reflected from a moving object, such as automobile traffic, channel equalization is even more difficult and expensive to achieve, since the standing wave pattern now moves in space. Also, the cost and complexity of channel equalization increases significantly with transmission rate.

Other steps to minimize or eliminate fading include providing a line-of-sight path between a transmitter and a receiver, the use of highly directional antennas and the use of multiple antennas at the receiver and/or the transmitter.

Transmissions in nearby cells or systems using the same carrier frequency may cause co-channel interference. Other services or equipment, as well as meteorological phenomena, utilizing or producing signals at the carrier frequency may also result in interference. Attempts to reduce or eliminate interference often include increasing the distance between the transmitter and the interfering equipment. This expedient may not be available, especially where large permanent structures or meteorological sources are involved, and if available, may prove very costly. Where the interfering equipment is a wireless communication system, interference reduction may be achieved through a decrease in frequency reuse by the interfering equipment. But, reducing frequency reuse in the interfering system concomitantly reduces that system's capacity.

Interference may be mitigated by spreading the signal over the frequency spectrum through the use of spread spectrum techniques. Interference may also be mitigated by using Orthogonal Frequency Division Multiplexing (“OFDM”) and coding across the frequency spectrum. This latter technique has been found to be as beneficial as spread spectrum techniques.

Moreover, OFDM has been found to ameliorate fading caused by multipath transmission. Alternatives to OFDM—Single Carrier Modulation (“SCM”)+equalization, direct sequence spreading and adaptive space-time coding—have been shown to be less advantageous. In any event, OFDM is the technique of choice at the high transmission rates used in broadband wireless systems. More particularly, the use of OFDM and multiple transmit/receive antennas in a broadband wireless system has led to the realization of an efficient, low error rate system for transmitting large quanta of data at high speed. For further discussion of the foregoing, reference is made to Document Number WP-1_TG-1, Version 1.2 (Dec. 15, 2000), a white paper of the Broadband Wireless Internet Forum (“BWIF”), entitled VOFDM Broadband Wireless Transmission and Its Advantages over Single Carrier Modulation.

A communication system is typically subject to a Media Access Control (“MAC”) protocol, i.e., a protocol that allocates the use of communication channels among independent, competing users. Various demand assignment (“DA”) MACs having variable length PDUs (such as ethernet-type data packets) are known. BWIF has selected DOCSIS (“Data Over Cable Service Interface Specification”) as this type of MAC for use by Fixed BWI systems, even though DOCSIS was developed for cable systems.

In the early days of networking, the choice of using circuit switching or packet switching was said to depend on performance and cost considerations. Although “correct” choices were said to be difficult to make, a general rule of thumb was set forth: Circuit switching is suitable for networking with constant bit rate voice or video, while packet switching is preferred for bursty data sources such as computer data sources. Today, packet switching is better developed and its performance/cost tradeoffs are well understood. Accordingly, packet switching is presently usually preferred as the multiplexing technique to be associated with all sources, including voice, video and data under both Internet Protocol (“IP”) and Asynchronous Transfer Mode (“ATM”) scenarios. For many, if not most, applications, packet switching has a throughput advantage over circuit switching of one hundred or more. When user-acceptable computer response times are considered, packet switching offers a WWW throughput advantage over circuit switching of more than fifteen. If a system has N users, circuit switching can deliver, at best, 1/N of the total channel capacity to each user. Packet switching offers a user access to the full bandwidth nearly instantaneously.

Thus, the types of wireless systems under consideration best utilize OFDM/packet switching in a demand assignment, variable length PDU system. See Document Number WP-2_TG-1, Version 1.1 (Dec. 5, 2000), a BWIF white paper entitled Media Access Protocols: Circuit Switching to DOCSIS. This type of system can be generally characterized as a Multichannel Multipoint Distribution Service (“MMDS”) in which (1) the base station continuously transmits data to, and makes these data available to, all of the CPEs served thereby, but (2) a Demand Assignment protocol is implemented, that is, in order to access data transmitted from the base station, the base station must first accept a service request previously transmitted thereto by a CPE and then grant bandwidth therefor.

As noted above DOCSIS is one type of Demand Assignment (“DA”) MAC, which, it has been determined, is the species of MAC that exhibits estimable performance for data and voice sources. Use of a DA MAC connotes that a CPE must first make a service request (or demand) for service from the base station. Various protocols, such as DOCSIS, are based on the premise that transmitted data packets constitute pre-defined IP packets or frames, although provisions exist for the transmission of ATM cells. Various protocols, including DOCSIS, support variable length Protocol Data Units (“PDU”) comprising Ethernet-type frames. The structure of the packet or frame, while somewhat flexible, is pre-defined, so that the packet cannot thereafter be broken, or the intended receiver, here, either the CPE or the base station, cannot access and read the data in the packet.

Notwithstanding the use of OFDM, multiple antennas and protocols such as DOCSIS, experience has shown that the wireless path between a base station and a CPE is more subject to degradation or transmission difficulties than is the HFC or other network between the base station and the originating station(s). Such degradation is usually manifested by the failure of one or more data packets transmitted by the base station to reach, or be properly received by, a user, or from the failure of a user request or demand to reach, or be properly received by, the base station. In the former event, the packet(s) is(are) accordingly “lost” to the receiving entity, the CPE.

Accordingly, there has arisen a need for a technique pursuant to which the CPE may automatically request a retransmission of the “missing” packet(s) from the transmitting entity for receipt by the receiving entity. Addressing this need is one goal of the present invention. As presently constituted, MMDS utilizing certain demand assignment, variable length PDU protocols, including DOCSIS, contain no provision for an Automatic Repeat Request (“ARQ”) to be made by CPE in response to the loss or degradation of one or more data packets in a message sent by a serving base station. The provision of ARQ function in the foregoing types of MMDS, broadband wireless communication systems is another goal of the present invention.

### SUMMARY OF THE INVENTION

In one aspect, the present invention is a method of operating an MMDS, broad band, wireless communications system. The system includes a base station having a first transmitter-receiver pair and one or more items of CPE, each having a second transmitter-receiver pair. The base station transmitter is primarily, but not solely, used to transmit to the receiver of the CPE data requested by the user thereof. The CPE transmitter is used to send messages which constitute requests to the base station receiver. These requests ask the base station to send to the CPE the user-requested data. Of course, the transmitter of the CPE is also used to send other data packets, such as those intended for delivery elsewhere in the system and various management data packets. The present invention contemplates adding ARQ packets to the types of data packets transmitted by the CPE to the base station.

Typically the user-requested data received at the CPE from the base station originates at a location remote from the base station and sent thereto via cable, optical fiber, satellite, other data generators/storage facilities or some combination thereof. The system preferably utilizes a genus of demand assignment MAC which has variable-length PDUs. In some embodiments the variable-length PDUs are ethernet-like data packets or frames and/or the MAC is DOCSIS.

In practicing the method, a header is inserted into each of a message's PDU (packet or frame) which includes either user-requested data or a user request for data that is sent by one of the transmitters (the first or the second transmitter) to the other receiver (the second or first receiver). Pursuant to the teachings of the present invention, the header in each of the packet or PDU's that constitute the message includes a unique “Sequence Number”. For purposes hereof, a Sequence Number is a numeric, alphabetic, alphanumeric, or other identifier which may be incremented or decremented according to a defined rule or algorithm. Accordingly, the Sequence Number of each data packet in a message are in a predetermined, fixed sequence and implement a modulo counter that may increment by “1” (however defined by the rule or algorithm) for each received packet or frame of a given message.

For example the N packets in a particular message may, starting with the first packet of the message, be numbered “101, 102, 103, 104 . . . N . . . N+1,” that is, after the first Sequence Number, each Sequence Number is one greater than the prior Sequence Number. Thus, the series “104,” “106,” “107” would indicate that packet denoted “105” is missing, because “106” immediately after “104” violates the above “N+1” rule or algorithm. Further, the twenty-seven packets in another message may be “numbered” (i.e., lettered) “aaa . . . aab . . . aac . . . aba . . . ccc,” that is, the twenty-seven packets are identified by the letters “a,” “b,” and “c” from “aaa” through “ccc” with the right-hand letter being incremented from “a” to “c” and then reset to “a,” then the middle letter being similarly incremented, and then the left-hand letter being so incremented. According to this algorithm or rule, the series “bbc,” “bca,” “bcc,” “caa” would indicate that the packet denoted “bcb” is missing between “bca” and “bcc.”

At the other receiver (second or first receiver), the Sequence Numbers of received packets and the sequence thereof are sensed and are evaluated according to the defined rule of incrementation or decrementation. If the other receiver (second or first receiver) receives all of the packets that should be present in a sequence as dictated by the applicable rule or algorithm, the associated transmitter (second or first transmitter) sends an Acknowledgment (“ACK”) message to the one receiver (first or second receiver) associated with the one transmitter (first or second transmitter) which sent the message (either requested data or a request for data). In preferred embodiments the ACK message comprises the absence of a signal, that is, the other transmitter (the second or first transmitter) sends no signal to the one receiver (first or second receiver). The present invention also contemplates that the ACK message comprise a selected signal other than the absence of a signal.

However, if the other receiver (second or first receiver) receives a message with one or more packets missing—that is, there are missing one or more Sequence Numbers, as determined by the application of the relevant algorithm—its associated transmitter (second or first transmitter) sends to the one receiver (the first or second receiver) a “Negative Acknowledgment” (“NAK”) message. The NAK message includes the missing Sequence Number(s). The NAK+missing Sequence Numbers constitutes the ARQ of the present invention.

After the one receiver (first or second receiver) receives the ARQ, the missing Sequence Numbers are identified and their corresponding packets are recovered. The packets originally missing from the message are re-sent by the one transmitter (the first or second transmitter) to the other receiver (second or first receiver) to be accessed by the user. At the other receiver (second or first receiver) the re-sent packets are inserted into the series of packets originally received in their proper positions according to the applicable rule or algorithm, and the entire message may thereafter be accessed.

In preferred embodiments, the transmission of the ARQ is effected by opening a variable length PDU, such as an ethernet packet, at the other (second or first) transmitter in response to its associated receiver having detected that the adherence to the defined rule or algorithm was not evidenced by the packets of the received message, and inserting into the opened Ethernet packet the Sequence Numbers of the missing packet(s). After closing the Ethernet packet, the ARQ is sent to the one (first or second) receiver, where the packet is opened and the missing Sequence Numbers are examined, following which the packets corresponding to the Sequence Number(s) of the missing packet(s) are recovered and are retransmitted by the one (first or second) transmitter to the other (second or first) receiver.

In another aspect, the present invention is apparatus, specifically, an MMDS, broad band, wireless communications system. The system includes a base station having a first transmitter-receiver pair and one or more items of CPE, each having a second transmitter-receiver pair. The base station transmitter is used to transmit to the receiver of the CPE data requested by the user thereof and to other functions described above. The CPE transmitter is used to send messages comprising data which constitute requests to the base station to send to the CPE receiver user-requested data. Typically the user-requested data received at the CPE originates at a location remote from the base station and sent thereto via cable, optical fiber, satellite, other data generators/storage facilities or some combination thereof. The system preferably utilizes a MAC pursuant to which the Protocol Data Unit (“PDU”) preferably has a variable length, DOCSIS being one species of such a MAC. The PDU may be an Ethernet-type data packet.

Facilities are provided for inserting a header into each packet of each Ethernet message. The message may include either user-requested data or a user request for data, that is sent by one of the transmitters (the first or the second transmitter) to the other receiver (the second or first receiver). Each header in each packet of the message has a unique Sequence Number, as defined above. Determining whether one or more packets are missing by examination of the sequence numbers is effected as described above regarding the method of the present invention.

At the other receiver (second or first receiver), facilities sense the Sequence Numbers of received packets and the sequence in which they are received and evaluate the sequence according to the defined rule or algorithm of incrementation or decrementation. If the other receiver (second or first receiver) receives all of the packets in the sequence dictated by the defined algorithm or rule, the associated transmitter (second or first transmitter) sends an Acknowledgment (“ACK”) message to the one receiver (first or second receiver) associated with the one transmitter (first or second transmitter) which sent the message (either requested data or a request for data). In preferred embodiments the ACK message comprises the absence of a signal, that is, the other transmitter (the second or first transmitter) sends no signal to the one receiver (first or second receiver). The present invention also contemplates that the ACK message comprise a selected signal other than the absence thereof.

However, if the other receiver (second or first receiver) receives a message with one or more packets missing, as determined by the application of the relevant algorithm or rule, facilities at its associated transmitter (second or first transmitter) send to the one receiver (the first or second receiver) a “Negative Acknowledgment” (“NAK”) message. The NAK message includes the missing Sequence Numbers. The combination of the NAK and the missing Sequence Nbumbers conmstitutes the ARQ hereof.

After the one receiver (first or second receiver) receives the ARQ, the missing Sequence Numbers are identified and their corresponding packets are recovered. The one (first or second) transmitter re-sends the packets originally missing from the message to the other receiver (second or first receiver) to be accessed by the user. At the other receiver (second or first receiver) the re-sent packets are inserted into the series of packets originally received in their proper positions according to the defined rule, and the entire message may thereafter be accessed by the user.

In preferred embodiments of the foregoing apparatus, facilities open an ethernet packet at the other (second or first) transmitter in response to its associated receiver detecting that the defined rule has been broken by a received message, and insert into the opened Ethernet packet the Sequence Numbers of the missing packet(s), thereby creating an ARQ. After closing the Ethernet packet, facilities send the ARQ to the one (first or second) receiver, which opens the packet and examines the missing Sequence Numbers, following which the packets corresponding to the Sequence Number(s) of the missing packet(s) are recovered and are re-transmitted by the one (first or second) transmitter to the other (second or first) receiver.

### BRIEF DESCRIPTION OF THE DRAWING

The present invention is described below in conjunction with the following drawing in which:

FIG. 1 is a generalized view of a wireless communication system, illustrating certain basic concepts relevant to the method and apparatus of the present invention;

FIG. 2 is a graphic illustration of an ethernet packet or frame according to both the prior art and to the present invention; and

FIG. 3 is a functional sequence illustration of a method according to the present invention and of the functions performed by the apparatus according to the present invention as generally shown in FIG. 1.

### DETAILED DESCRIPTION OF THE INVENTION

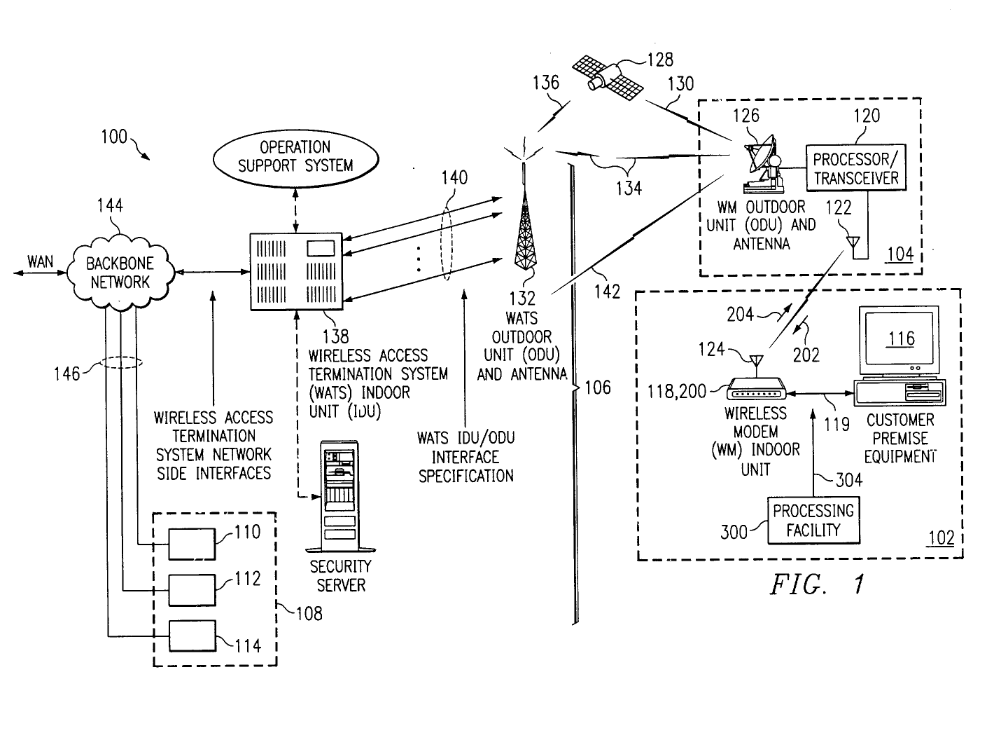

Referring first to FIG. 1, there is shown a generalized, overview of a wireless communication system 100 in which the method and apparatus of the present ideally find use.

The system 100 includes a user or customer site 102, also referred to as the down stream or down load location, a base station 104, also referred to as the up stream or up load location, or the head end, and plural originating sites, collectively referred to by the reference numeral 106. The originating sites 106 may comprise any of a variety of data and information sources 108, including computers 110, servers 112 and data/information storage units 114 of any convenient configuration. Typically, the data/information sources 108 may comprise some or all of the World Wide Web (“WWW”), multiple computers, servers and storage units 110,112,114 of which are scattered about the world. The function of the system 100 is to permit a user at the user site 102 to access data and information created by or stored in the data and information sources 108 on request.

The customer site 102 may include one or more units 116 of CPE, such as PC's, laptop computers, palm computers, other personal data assistants, servers, data storage units, or the like. A user may request access to data or information from the data and information sources 108 and thereafter accesses the data or information via one or more of the CPE units 116. Requests for data or information and the access thereto are effected via a wireless modem 118 located at the site 102 and associated with the CPE 116, as indicated by the reference numeral 119. The modem 118, which is also associated with or includes a transmitter/receiver (shown at 200 and described below), communicates with a transceiver 120 in the base station 104 via one or more transmit/receive antennas 122 connected to the transceiver 120 at the base station 104 and one or more transmit/receive antennas 124 connected to the transmitter/receiver of the modem 118.

The stationary wireless system 100 may be generally configured in much the same way as a cellular telephone system is configured. That is, the base station 104 may service a number of user sites 102 within a given cell (not shown), while in each additional cell of the system 100 there is a similar base station 104 servicing multiple user sites 102. Each cell may be adjacent to or slightly overlap multiple other cells.

The transceiver 120 may receive data and information to be accessed by user sites 102 in a number of ways. For example, a transceiving station 126, which is in or associated with the base station 104 and is connected to the transceiver 120, may receive signals from and send signals to one or more transceiving satellites 128, as shown by the transmission path 130, or to one or more remote land-based transceiving stations 132, as shown by the path 134. The satellite 128 may communicate with the transceiving 132 via a path 136, eliminating, or as an alternative to, the path 134. The transceiving station 132 may receive data and information from further upstream (“US”) systems 138 by cable, fiber optics, HFC, wirelessly or via any other convenient transmission media, as designated by the reference numeral 140. The base station 104 may also be in direct communication with the upstream (“US”) systems 138, in any convenient fashion, as shown by the path 142. The upstream (“US”) systems 138 may communicate over a backbone network 144, which may be considered as including the data and information sources 110,112,114, connected to the system 100 as indicated at 146, by wire, fiber optics, HFC or wirelessly. The system 100, excluding the user site 102 the base station 104 and the elements located thereat, may also be referred to as the backbone network 144.

Requests for data/information transmitted from the user site 102 to the base station 104 are communicated to the data and information sources 110,112,114 via the backbone network 144. The requested data/information is thereafter communicated to the base station 104 from the sources 110,112,114,128,138 along the backbone network 144 and from the base station 104 to the requesting user sites 102.

The present invention relates to communications between the base station 104 and the CPE 116 respectively served thereby. As noted above, the 2.5 to 2.7 GHz band was originally intended in the US to be used primarily for instructional television broadcasts. This band was found to be under-utilized for that purpose, so the FCC granted permission for this spectrum to be utilized by fixed wireless communication systems, including fixed BWA and BWIA applications and systems, of the type which preferably includes the base station 104 and various CPE entities 102,116 served by the base station 104.

The base station 104 wirelessly communicates with the CPE 116 of one or more users who randomly and periodically desire to access such data. In preferred embodiments hereeof, the base station 104 and CPE are transceiving points of a wireless, demand assignment Multichannel Multipoint Distribution Service (“MMDS”) of the point-to-multipoint type utilizing a MAC which sends data and information in packets of variable length. An example of such a MAC is DOCSIS (a demand assignment protocol). As a point-to-multipoint system, the head end or base station 104 continuously transmits modulated signals downstream (“DS”) to the CPE 116 in the user site 102 and all of the CPE entities 116 (in 102) served by the base station 104. The CPE 116 of all user sites 102 is continuously in the “listening” mode. Upstream (“US”) transmission from the CPE 116,118,200 to the base station 104 occurs when the CPE 116,118 is operated by a user to request a time slot during which it can receive, conflict-free, from the base station 104 data and information over the entire bandwidth. In effect, in this type of system, the CPE 116 must reserve bandwidth before data and information obtained from the backbone network 144 by the base station 104 may be transmitted to the user site 102. Although it is preferred that the packets transceived by the base station 104 and the CPE 116,118 are IP packets—for example, ethernet packets—this type of system may also support ATM (“Asynchronous Transfer Mode”) cell transmission.

Thus, it is necessary that two-way communications tACKe place between each base station 104 and each user's CPE 116,118 served thereby. That is, each base station 104 must be able to send data and information to the CPE's 116,118 served thereby—so-called down link (down load or down stream) data—and each CPE 116,118 must be able to send data and information to the base station 104 serving it—so-called up link (up load or up stream) data.

As noted above, while the foregoing type of system 100 offers many advantages, the base station/CPE 104/116,118 link is more likely to experience incorrect or incomplete data transfers than is the backbone network 144. Presently, the type of fixed wireless system described herein has no provision for a function (ARQ) which permits a user to obtain missing information or data, that is, information or data transmitted by the base station 104 which does not reach—or is corrupted when it reaches—the modem 118 of the customer site 102. Accordingly, the present invention adds an ARQ function to the system 100 by inserting an ARQ “shim” between the OFDM physical layer and the MAC protocol.

The customer site 102 includes the modem 118, and its associated transceiver 200, connected at 119 to the CPE 116 whereat information and data received by the antenna/transceiver/modem 124,200,118 is downloaded and/or displayed on the CPE 116. The modem 118 and the transceiver 200 may be included in an integral unit or may be separate modules. Instead of the single antenna shown in FIG. 1, two or more antennas may receive downstream (“DS”) signals 202 from the base station 104. The use of more than one antenna at the customer site 102 provides transmission diversity which ameliorates fading, as discussed earlier. Upstream (“US”) signals 204 are sent by the CPE 116 via the transceiver 200 and antenna 124 to the base station 104. Even without the ARQ of the present invention, such upstream (“US”) transmission is necessary when the customer site 102 needs to reserve bandwidth for the receipt of information and data available via the base station 104 from the various origination sources 108,138,144, 128, etc. Upstream (“US”) transmission also occurs, inter alia, when a customer site sends data packets to another customer site in the system 100 or in another system or when it is necessary for the customer site 102 to send other management data to the base station 104

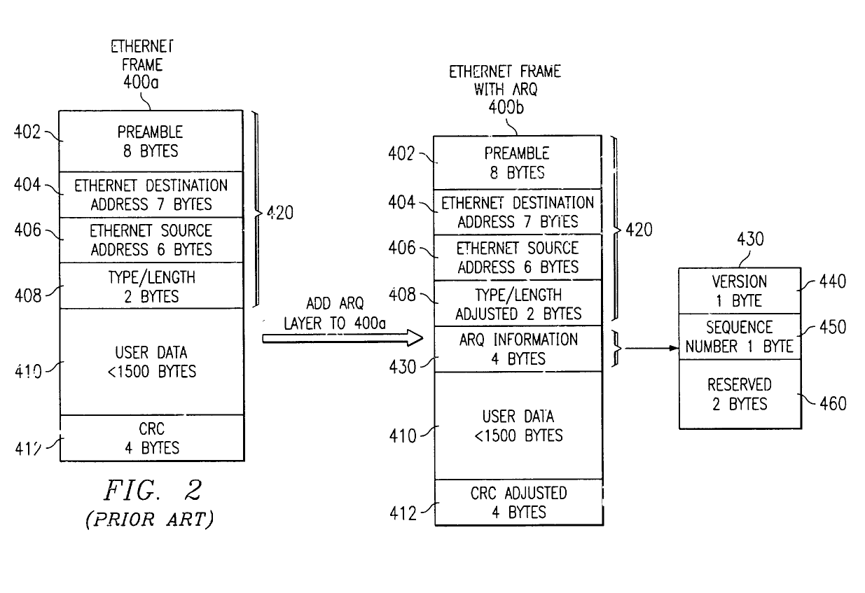

According to the method and apparatus of the present invention, when a data packet (400, see FIG. 2) sent by the base station 104 in a downstream (“DS”) transmission 204 is not received at the site 102, a processing facility 300, associated with the other facilities 116,118,200 as shown at 304, determines this fact. The processing facility 300 may be integral with the modem 118 and/or the transceiver 200, or may constitute a separate module.

If an examination by the processing facility 200 of the Sequence Numbers determines that one or more packets of a transmission is missing—that one or more gaps in the Sequence Numbers is present—it effects an upstream (“US”) transmission 204 by the transceiver 200 to the transceiver 120 of an ARQ. The ARQ effectively alerts that one or more packets of the message were missing, identifies the missing packet or packets and requests that the missing packets be re-transmitted.

In response to this ARQ, the transceiver 120 re-sends the missing packet or packets to the transceiver 200 and thence to the CPE 116. The processing facility 300 or other facilities then assemble the packets—formerly received packets and re-sent packets—in the proper order using therefor the Sequence Numbers to achieve same.

FIG. 2 is a graphic representation of two frames or packages 400. The packets 400 may be ethernet packets. On the left is a packet 400a according to the prior art. On the right is a packet 400b according to the present invention illustrating the manner of inserting an ARQ layer or “shim” 430 therein. The ARQ layer 430 is responsible for performing all ARQ-related functions, including ACK, NAK, packet sequence numbering and packet sequence number checking.

The prior art ethernet packet 400a of the prior art includes a preamble layer or field (for synchronization) 402 (8 bytes), an ethernet host destination address layer or field 404 (6 bytes), an ethernet host source address layer or field 406 (6 bytes), a layer or field 408 indicating the type of data encapsulated by the packet 400a (2 bytes), a layer or field 410 (<1500 bytes) containing the data or information intended to be received by the user site 102, and a layer or field 412 (4 bytes) implementing a cyclic redundancy check (“CRC”), used for error detection. The first four layers or fields 420,404,406,408, collectively identified by the reference numeral 420, may be referred to as the MAC layer or field 420. The layer 410 is called the data layer or field; besides data, it may include the internet address of the destination and source hosts.

As shown in FIG. 2, an ethernet frame or layer 400b containing an ARQ function according to the present invention includes an ARQ shim layer or field 430 of four bytes between the MAC layer 420 and the data layer 410. This addition requires the adjustment or modification of the layer 408 and of the CRC layer 412 so that each indicates/recognizes that the packet 400a has been lengthened into the packet 400b by the addition of four bytes. The MAC used, in this example DOCSIS, must be one which permits the longer ethernet frame 400b to be utilized.

To the right of the ethernet layer 400b some detail of the shim layer 430 is illustrated. Specifically, a first byte (8 bits) 440 identifies the version of the ARQ which is implemented in the frame 400b. A second byte (8 bits) 450 comprises the Sequence Number of the frame 400b. According to the present invention the Sequence Number in layer 450 is a modulo counter that increments by “1” according to the rule or algorithm, discussed above, for each successive packet 400b of a particular message. Lastly, layer 460 may comprise 2 bytes (16 bits) for future use.

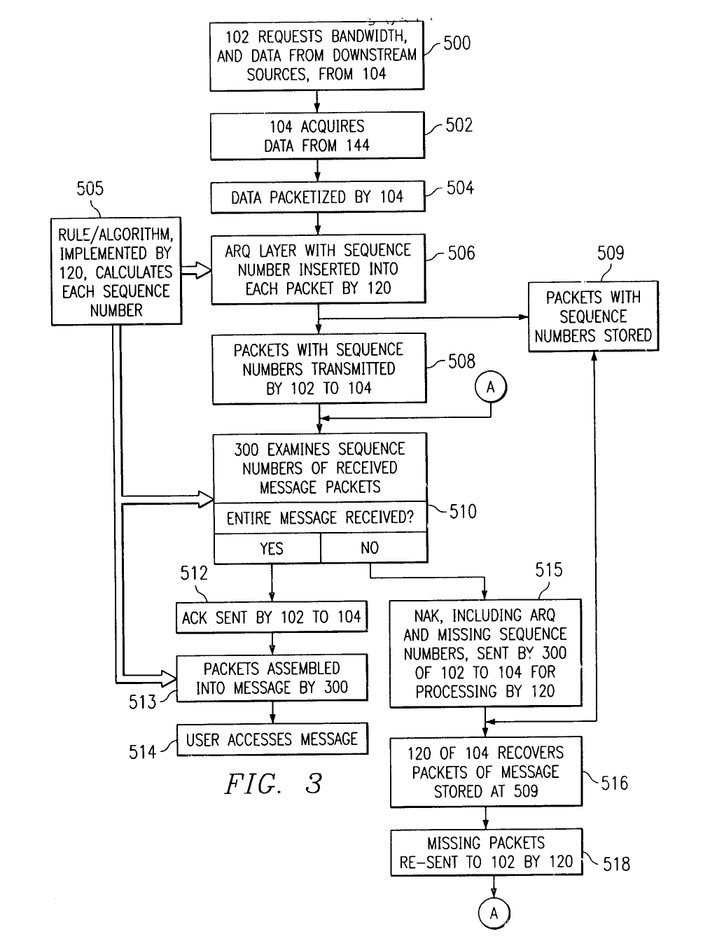

FIG. 3 illustrates the operation of the system 100 which uses the type of packet 400b discussed above as implemented with the ARQ function.

In step 500, the CPE 116 in a user site 102 sends an upstream (“US”) message to the base station 104 requesting a quantum of information or data from one or more upstream (“US”) sources 108,128,138 or other sources connected to the backbone network 144, including WWW sites. Following allocation by the base station 104 to the user site 102 of bandwidth, in step 502, in response to the request of step 500, the transceiver/processor 120 and other facilities in the base station 104 acquire the requested information/data, which is then packetized in step 504. The ARQ layer 430 is placed in each packet 400b, with the proper Sequence Number—as dictated by the applicable rule or algorithm shown at step 505—inserted therein, as denoted at step 506. According to the algorithm, subsequent packets 400b receive Sequence Numbers which are “1” greater than the Sequence Number of the immediately prior packet 400b, all as dictated by the applicable rule or algorithm 505 that is implemented in the transceiver/processor 120.

In step 508, the packetized message, including the serial Sequence Numbers, is transmitted over time in a series of packets 400 to the user site 102. As shown at step 509, the packets, including their Sequence Numbers may be temporarily stored in the processor/transceiver 120.

In step 510, following receipt of the message at the user site 102, the processor 300 examines the Sequence Numbers of the received packets 400b according to the same rule or algorithm as implemented in the processor/transceiver 120. If there are no missing Sequence Numbers (indicating that there are no missing packets), as indicated at “YES” in step 510, then the entire message has been received, and the user site 102 appropriately indicates same by an ACK message sent to the base station 104, as indicated at step 512. Preferably, the ACK message takes the form of a “no upstream (‘US’)” transmission (i.e., the lack of any transmission) from the user site 102 to the base station 104. Alternatively the ACK message may comprise a transmission of a selected signal.

Following the foregoing, at step 513, the processor 300 associates or assembles the packets 400b in the proper order, as dictated by their Sequence Numbers, thereby assembling the transmitted message and making it available to the CPE 116. Thereafter, the user analyzes, downloads, uploads or other wise utilizes or manipulates the information and data in the message using the CPE 116, as shown at step 514.

If, at step 510, the examination of the Sequence Numbers by the processor 300 indicates that one or more packets 400b of the message are missing (indicated at “NO” in step 510), as shown at step 515, the processor 300 assembles and sends an upstream (“US”) NAK message to the base station 104. The ARQ 430 indicates that packets 400b were missing and provides the missing Sequence Numbers, that is, the Sequence Numbers of the missing packets 400b. Upon receipt of the NAK message, the processor/transceiver 120 recovers the message from temporary storage 509, as shown at step 516, and effects retransmission of the packets 400b identified by the user site 102 as missing, as indicated at step 518. As shown in FIG. 3—see the path from step 518 to step 510—this process continues until the entire message is received by the user site 102.

Those having skill in the art will appreciate that the main thrust of the present invention resides in the provision of an ARQ function in a fixed wireless system the DPUs of which are variable in in a simple, straightforward manner under the influence of a simple algorithm, all as described above and as set forth in the following claims.

What is claimed is:

1. A method of operating a fixed wireless communications system having abase station and customer premises equipment (“CPE”), the system utilizing demand assignment (“DA”) media access control (“MAC”) and variable length protocol data units (“PDUs”) for messages between the base station and the CPE, which comprises:
in response to the failure of the CPE to receive all of the PDUs of a message from the base station,
opening a PDU at the CPE, inserting ARQ data thereinto,
closing the PDU, and
transmitting the ARQ data-containing PDU to the base station; and
in response to the receipt by the base station of the ARQ data-containing PDU,
opening the ARQ data-containing PDU and removing the ARQ data,
determining from the ARQ data which PDUs were missing at the CPE, and
re-sending the missing PDUs from the base station to the CPE.

2. A method as in claim 1, wherein:
the system is a multichannel multipoint distribution system.

3. A method as in claim 2, wherein:
the MAC is DOCSIS.

4. A method as in claim 1, wherein:
whether or not the CPE receives all of the PDUs of a message from the base station is ascertained by
inserting a different sequence number into each PDU, and
at the CPE determining if any sequence number is missing.

5. A method as in claim 4, wherein:
the ARQ data includes any missing sequence numbers, which the base station utilizes in identifying those PDUs to be re-sent.

6. A method as in claim 5, wherein:
the sequence numbers are generated according to a rule which is available at the base station and the CPE.

7. A method as in claim 6, wherein:
each sequence number is a member of a series, adjacent members of which differ by a common factor.

8. A method as in claim 7, wherein:
the series and its members include alpha-numeric characters.

9. A method as in claim 1, wherein:
the PDUs are Ethernet packets which include a plurality of layers or fields.

10. A method as in claim 9, wherein:
each Ethernet packet is modified to include an ARQ layer inserted between two originally adjacent layers of the Ethernet packet.

11. A method as in claim 10, wherein:
the ARQ layer is inserted between a data type layer and a user data layer.

12. A method as in claim 10, wherein:
the ARQ layer includes a sequence number.

13. A method as in claim 12, wherein:
whether or not the CPE receives all of the Ethernet packets of a message from the base station is ascertained by inserting a different sequence number into the ARQ layer of each Ethernet packet, and
at the CPE determining if any sequence number is missing.

14. A method as in claim 13, wherein:
the ARQ data includes any missing sequence numbers, which the base station utilizes in identifying those Ethernet packets to be re-sent.

15. A method as in claim 14, wherein:
the sequence numbers are generated according to an algorithm which is available at the base station and the CPE.

16. A method as in claim 15, wherein:
the sequence numbers are members of a series, adjacent members of which differ by a common factor.

17. A method as in claim 16, wherein:
the series and its members include alpha-numeric characters.

18. A fixed wireless communications system having a base station and customer premises equipment (“CPE”), the system utilizing demand assignment (“DA”) media access control (“MAC”) and variable length protocol data units (“PDUs”) for messages between the base station and the CPE, which comprises:
a processing facility at the CPE for detecting the failure of the CPE to receive all of the PDUs of a message from the base station and in response to so detecting for opening a PDU at the CPE, inserting ARQ data thereinto, closing the PDU, and transmitting the ARQ data-containing PDU to the base station; and
a processor at the base station responsive to the receipt by the base station of the ARQ data-containing PDU for opening the ARQ data-containing PDU and removing the ARQ data, determining from the ARQ data which PDUs were missing at the CPE, and re-sending the missing PDUs from the base station to the CPE.

19. A system as in claim 18, wherein:
the system is a multichannel multipoint distribution system.

20. A system as in claim 19, wherein:
the MAC is DOCSIS.

21. A system as in claim 18, wherein:
the processor at the base station inserts a different sequence number into each PDU of the message, and
the processing facility at the CPE determines if any sequence number is missing, thereby ascertaining whether or not the CPE has received all of the PDUs of the message.

22. A system as in claim 21, wherein:
the ARQ data includes any missing sequence numbers, which the processor at the base station utilizes in identifying those PDUs to be re-sent.

23. A system as in claim 22, wherein:
the sequence numbers are generated according to a rule which is available at the base station's processor and at the CPE's processing facility.

24. A system as in claim 23, wherein:
each sequence number is a member of a series, adjacent members of which differ by a common factor.

25. A method as in claim 24, wherein:
the series and its members include alpha-numeric characters.

26. A system as in claim 18, wherein:
the PDUs are Ethernet packets which include a plurality of layers or fields.

27. A system as in claim 26, wherein:
each Ethernet packet is modified to include an ARQ layer inserted by the processor at the base station between two originally adjacent layers of the Ethernet packet.

28. A system as in claim 27, wherein:
the ARQ layer is inserted between a data type layer and a user data layer.

29. A system as in claim 28, wherein:
the ARQ layer includes a sequence number.

30. A system as in claim 18, wherein:
the processor at the base station inserts a different sequence number into each Ethernet packet of the message, and
the processing facility at the CPE determines if any sequence number is missing, thereby ascertaining whether or not the CPE has received all of the PDUs of the message.

31. A system as in claim 30, wherein:
the ARQ data sent by the processing facility at the CPE includes any missing sequence numbers, which the processor at the base station utilizes in identifying those Ethernet packets to be re-sent.

32. A system as in claim 31, wherein:
the sequence numbers are generated according to an algorithm which is available at processor of the base station and processing facility of the CPE.

33. A system as in claim 32, wherein:
the sequence numbers are members of a series, adjacent members of which differ by a common factor.

34. A method as in claim 33, wherein:
the series and its members include alpha-numeric characters.
